(19) United States
(12) Patent Application Publication
(10) Pub. No.: US 2010/0262500 A1
(43) Pub. Date: Oct. 14, 2010

(54) METHOD AND APPARATUS FOR PROVIDING THE SAME ADVERTISEMENT

(75) Inventor: Se-One Yu, Seoul (KR)

Correspondence Address: FENWICK & WEST LLP, SILICON VALLEY CENTER, 801 CALIFORNIA STREET, MOUNTAIN VIEW, CA, 94041, US

(73) Assignee: CDNETWORKS CO., LTD., Seoul (KR)

(21) Appl. No.: 12/739,387

(22) PCT Filed: Oct. 30, 2008
(86) PCT No.: PCT/KR2008/006434

§ 371 Date: Apr. 22, 2010

(30) Foreign Application Priority Data
Oct. 30, 2007 (KR) 10-2007-0109784

(51) Int. Cl. G06Q 30/00

(52) U.S. Cl. 705/14.73

(57) ABSTRACT

Identical Internet advertisement providing method and system are provided. The identical Internet advertisement providing system receives cookie information from a client, receives advertisement exposure information from a server to which the client is being connected, reads advertisement data using the received cookie information and advertisement exposure information, and transmits the read advertisement data to the client. Accordingly, it is possible to provide an identical advertisement to an Internet user regardless of change in web site or web page, thereby maximizing an advertisement effect.

### TECHNICAL FILED

The present invention relates to identical Internet advertisement providing method and system, and more particularly, to Internet advertisement providing method and system that can provide an identical advertisement to a user even when the user moves to different web pages in Internet.

### BACKGROUND ART

Various types of advertisements are known which includes advertisements using broadcast mediums such as sky-wave broadcast and cable broadcast and banner advertisements and pop-up advertisements using web pages in Internet.

Such advertisements gives users opportunity of acquiring information on new goods or services and gives sponsors means for informing the users of the new goods or services to enhance the purchase of the goods or services.

However, since the advertisements are generally provided to unspecified persons, advertisement effects may not be great depending on users' tastes such as not being interested in the goods or services.

With the advancement of personal mediums such as user created contents (USS) and blogs using communication networks such as Internet and the increasing requirement for services specialized every user, there is a need for custom-made advertisements or customized advertisements corresponding to the users' tastes.

However, it is general that Internet users do not use only one web site but enjoy the web surfing while moving to plural web sites and that different advertisements are provided to the Internet users from the web sites or web pages when the Internet users move to the web sites or web pages.

On the other hand, identical advertisements should be continuously exposed to identical users to maximize the advertisement effects.

However, since it is difficult to grasp in advance to what web site or web page an Internet user moves, it is difficult to provide an identical advertisement to an identical Internet user regardless of change in web site or web page.

### DISCLOSURE OF INVENTION

### Technical Problem

A technical goal of the invention is to provide identical Internet advertisement providing method and system that can provide an identical advertisement to an identical Internet user regardless of change in web site or web page.

Another technical goal of the invention is to provide identical Internet advertisement providing method and system that can allow web sites or web pages to provide identical advertisements to maximize an advertisement effect even when the web sites or web pages are changed.

Other goals of the invention will be easily understood from the following description.

### Technical Solution

According to an aspect of the invention, there is provided an identical Internet advertisement providing method.

The identical Internet advertisement providing method includes: (a) receiving cookie information from a client; (b) receiving advertisement exposure information from a server to which the client is being connected; (c) reading advertisement data using the received cookie information and advertisement exposure information; and (d) transmitting the read advertisement data to the client.

In the step of (a), the cookie information may be received from a web browser installed in the client.

In the step of (a), the cookie information may be received through the server to which the client is being connected.

In the step of (a), the cookie information may include user information of the client and the advertisement data may be read using the user information in the step of (c).

In the step of (b), the advertisement exposure information may include at least one of a size, a position, and a display method of a window on which the transmitted advertisement data is displayed.

The step of (c) reading the advertisement data may be carried out by generating a query using the cookie information and the advertisement exposure information.

The step of (d) transmitting the read advertisement data to the client may be carried out even when the server to which the client is being connected is changed.

According to another aspect of the invention, there is provided an identical Internet advertisement providing system.

The identical Internet advertisement providing system includes: a cookie information receiver receiving cookie information from a client; an advertisement exposure information receiver receiving advertisement exposure information from a server to which the client is being connected; an advertisement data detector reading advertisement data using the cookie information and the advertisement exposure information received by the cookie information receiver and the advertisement exposure information receiver, respectively; and an advertisement data transmitter transmitting the advertisement data read by the advertisement data detector to the client.

The cookie information receiver may receive the cookie information from a web browser installed in the client.

The cookie information receiver may receive the cookie information through the server to which the client is being connected.

The cookie information received by the cookie information receiver may include user information of the client and the advertisement data detector may read the advertisement data using the user information included in the cookie information.

The advertisement exposure information received by the advertisement exposure information receiver may include at least one of a size, a position, and a display method of a window on which the transmitted advertisement data is displayed.

The advertisement data detector may read the advertisement data by generating a query using the cookie information and the advertisement exposure information.

The advertisement data transmitter may transmit the read advertisement data to the client even when the server to which the client is being connected is changed.

According to another aspect of the invention, there is provided a recording medium having recorded a program for embodying an identical Internet advertisement providing method.

The recording medium has recorded a program of instruction words that can be read and executed by a digital processor so as to embody the identical Internet advertisement providing method, the identical Internet advertisement providing method including the steps of: (a) receiving cookie information from a client; (b) receiving advertisement exposure information from a server to which the client is being connected; (c) reading advertisement data using the received cookie information and advertisement exposure information; and (d) transmitting the read advertisement data to the client.

In the step of (a), the cookie information may be received from a web browser installed in the client.

In the step of (a), the cookie information may be received through the server to which the client is being connected.

In the step of (a), the cookie information may include user information of the client and the advertisement data may be read using the user information in the step of (c).

In the step of (b), the advertisement exposure information may include

at least one of a size, a position, and a display method of a window on which the transmitted advertisement data is displayed.

The step of (c) reading the advertisement data may be carried out by generating a query using the cookie information and the advertisement exposure information.

The step of (d) transmitting the read advertisement data to the client may be carried out even when the server to which the client is being connected is changed.

Other goals, advantages, and features of the invention will be clearly understood from the following detailed description of exemplary embodiments with reference to the accompanying drawings.

### BRIEF DESCRIPTION OF DRAWINGS

FIG. 1 is a diagram illustrating a configuration of an Internet advertisement providing system according to an exemplary embodiment of the invention.

FIG. 2 is a diagram illustrating a configuration of an advertisement server according to an exemplary embodiment of the invention.

FIG. 3 is a diagram illustrating a state where an identical Internet advertisement is provided at the time of moving to a different web site according to an exemplary embodiment of the invention.

FIG. 4 is a flowchart illustrating a procedure of carrying out an identical Internet advertisement providing method according to an exemplary embodiment of the invention.

### MODE FOR THE INVENTION

Hereinafter, exemplary embodiments of the invention will be described in detail with reference the accompanying drawings. To facilitate entire understanding of the invention, like reference numerals reference like elements.

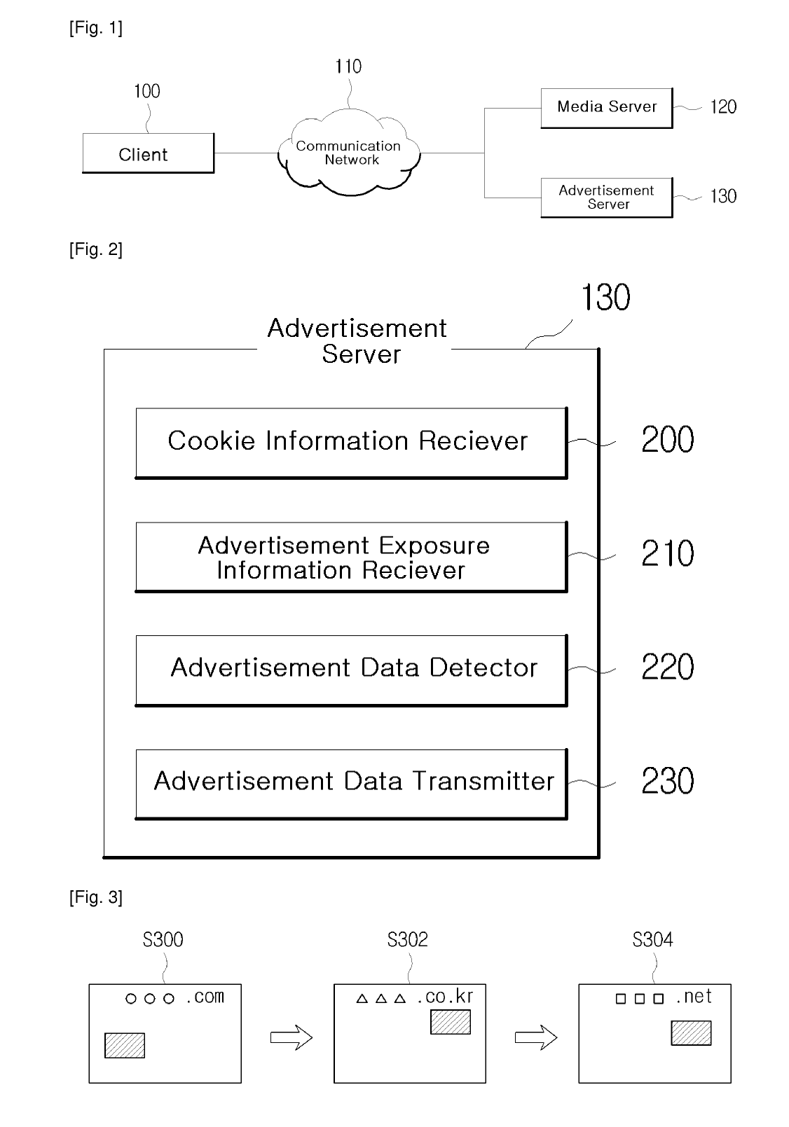

First, an Internet advertisement providing system for an identical advertisement to an identical Internet user according to an exemplary embodiment of the invention will be described with reference to FIG. 1.

FIG. 1 is a diagram illustrating a configuration of an Internet advertisement providing system according to an exemplary embodiment of the invention.

As shown in FIG. 1, the Internet advertisement providing system according to the exemplary embodiment of the invention includes a client 100, a media server 120, and an advertisement server 130.

The client 100 is a device transmitting a request for receiving contents, which are provided from the media server 120 through a communication network 110, to the media server 120 and receiving the contents from the media server 120.

The client 100 may include a web browser (not shown) for connection to the media server 120 and an application (not shown) reproducing the contents. It is well known that the web browser and the application can be installed in the client 100 in the form of programs.

On the other hand, when the contents to be reproduced by the client 100 are provided through a specific web page, the application reproducing the contents may be driven in the form of plug-in, which can be driven in the web browser providing displaying the web page, and may reproduce the contents.

The client 100 is not limited as long as it has a communication function for connection to the media server 120 and the advertisement server 130, has a program for reproducing the received contents, and has a display screen outputting reproduced images.

Examples of the client 100 can include user personal computers (PC) and wireless terminals such as mobile phones and personal digital assistants (PDA).

The client 100 is connected to the media server 120 and the advertisement server 130 through the communication network 110. In this embodiment, the communication network 110 includes Internet and a mobile communication network. The Internet includes all international open-type network structures providing the TCP/IP protocol and various services as the upper layers thereof, that is, HTTP (Hyper Text Transfer Protocol), Telnet, FTP (File Transfer Protocol), DNS (Domain Name System), SMTP (Simple Mail Transfer Protocol), SNMP (Simple Network Management Protocol), and NFS (Network File Service).

The mobile communication network includes a base station (BS), a mobile telephone switching office (MTSO), a home location register (HLR), an access gate way, and a packet data serving node (PDSN).

The media server 120 receives a request for providing contents selected by a user through the client 100 and transmits the contents to the client 100 through the communication network 110 on the basis of the received request for providing contents.

The contents provided from the media server 120 may include various kinds of contents such as UCC, games, and music, in addition to image data such as movies and dramas.

The media server 120 is exemplified in FIG. 1, where it is assumed that the advertisement data is provided along with the contents. On the other hand, when a user views confirms details of a web page and an advertisement is provided through the web page, the media server 120 shown in FIG. 1 may be a web server.

Both when the advertisement is provided along with the contents and when the advertisement is provided through the web page, the web server and the media server 120 may be included in the Internet advertisement providing system according to the invention.

The advertisement server 130 receives information on the client 100, which should receive the advertisement data, through the media server 120 or from the client 100.

The information on the client 100 may be cookie information stored in the client 100 through the web browser installed in the client 100.

The cookie is a temporary file storing information generated when an Internet user accesses a specific web server and the like and is automatically prepared and updated by the web browser installed in the client.

In the embodiment of the invention, when the advertisement server 130 is connected to the client 100 through the media server 120 or the web server, the advertisement server receives the cookie information from the web browser installed in the client 100.

The advertisement server 130 transmits identical advertisement data to the identical client 100 by the use of the cookie information, even when the client 100 changes web pages in the identical web server or moves to another server.

On the other hand, it is possible to provide a customer-made advertisement by the use of user information included in the cookie information, as well as to provide the identical advertisement data by the use of the cookie information when the web page is changed or the server is changed.

That is, when the user information is included in the cookie information received from the client 100, it is possible to generate a query for detecting the advertisement data to be provided to the client 100 by the use of the user information, to detect the corresponding advertisement data, and to provide the detected advertisement data to the client 100.

On the other hand, the size, position, advertisement providing method, and the like of a picture others in the web page through which the advertisement is provided may vary. In this case, in order to provide the optimal advertisement data, it is possible to receive at least one information on the size, position, advertisement providing method, and the others in the web page the size and position of the picture through which the advertisement is exposed and information on the advertisement providing method from the web server or the media server and to provide a user with the identical advertisement, which is the customer-made advertisement optimal to the picture even when the user moves to a different web page or a different web site.

On the other hand, the information on the advertisement providing method may be information on a method of allowing an advertisement to be exposed to the user, such as whether the advertisement is provided in the form of pop-up or is included in a web page, or whether the advertisement is a simple image advertisement or a moving advertisement.

The configuration of the advertisement server 130, which is an advertisement providing apparatus enabling to provide an identical advertisement regardless of the change in web page or web site, will be described now with reference to FIG. 2.

FIG. 2 is a diagram illustrating a configuration of the advertisement server 130 according to an exemplary embodiment of the invention.

As shown in FIG. 2, the advertisement server 130 according to the exemplary embodiment of the invention includes a cookie information receiver 200, an advertisement exposure information receiver 210, an advertisement data detector 220, and an advertisement transmitter 230.

The cookie information receiver 200 receives the cookie information, which is transmitted by the client 100, from the media server 120 or the client 100.

As described above, the advertisement server 130 receives information on the client 100, which should receive the advertisement data, through the media server 120 or from the client 100. The information on the client 100 may be the cookie information stored in the client 100 through the web browser installed in the client 100.

The cookie information can be received by the use of the web browser installed in the client 100.

When the user accesses a different web server or media server 120 by the use of the client 100, the advertisement exposure information receiver 210 receives information on the part of the corresponding web site or web page, which the advertisement is exposed from at the time of moving to a different web site or changing to a different web page, from the corresponding web server or media server 120.

The advertisement exposure information may include information on the size and position of a web page from which the advertisement is exposed and information on the advertisement providing method.

The advertisement data detector 220 generates a query for detecting the advertisement data by the use of the received cookie information and detects the advertisement data.

It is also possible to provide a customer-made advertisement by generating the query and detecting the advertisement data.

On the other hand, the query can be generated on the basis of priority information previously set by an operator of the advertisement server 130.

The advertisement data transmitter 240 transmits the advertisement data detected and read by the advertisement data detector 220 to the corresponding client 100 by the use of the received cookie information or the user information received from the media server 120 or the web server.

According to the configuration of the advertisement server 130, when the user moves to a different web site or changes the web page or when the user accesses a different server, it is possible to provide a user with the identical Internet advertisement.

When the size or position of the advertisement exposed from the web site or web page and the advertisement providing method change, it is possible to provide a user with the identical Internet advertisement to the identical user with the optimal size and position and the optimal advertisement providing method.

It is also possible to provide a customer-made advertisement having an excellent advertisement effect for the corresponding user by the use of the user information included in the cookie information.

FIG. 3 is a diagram illustrating a state where the identical Internet advertisement is provided when a user moves to a different web site according to an exemplary embodiment of the invention.

As shown in FIG. 3, when a user initially accesses a web site by the use of the client 100 in step 300, the position or size of the corresponding web site or web page from which the advertisement is exposed and the advertisement providing method are determined in advance, and an advertisement with a predetermined size is exposed at a predetermined position by a predetermined method.

In step S320302 or S304, when the user moves to a different web site, the exposure position or size of the advertisement may change, the advertisement providing method may change., and So it is difficult to grasp whether the identical user moves to a different web site.

However, according to the embodiment of the invention, it is possible to provide the identical advertisement to the identical user, by grasping that the identical user moves to a different web site on the basis of the cookie information and receiving the information on the exposure position or size of the advertisement and the information on the advertisement providing method from the web site or the like.

The procedure of embodying the Internet advertisement providing method according to an exemplary embodiment of the invention will be described now with reference to the configuration of the advertisement server 130 and the example where the identical Internet advertisement is provided with the change in web site.

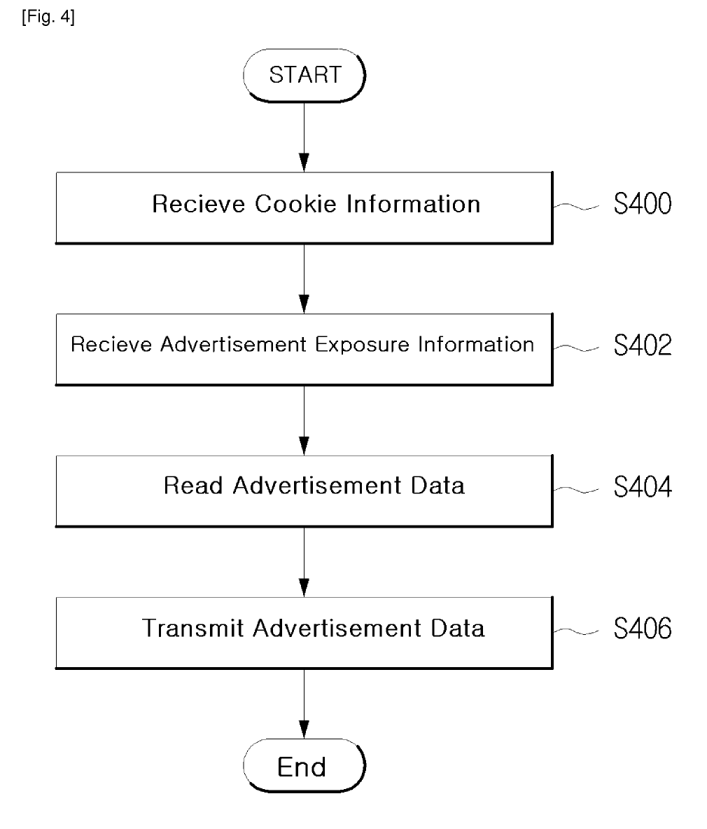

FIG. 4 is a flowchart illustrating a procedure of embodying the identical Internet advertisement method according to an exemplary embodiment of the invention.

As shown in FIG. 4, in the identical Internet advertisement providing method, the cookie information is first received from the client 100 or through the media server 120 (S300).

As described above, the cookie information is a temporary file storing information generated when an Internet user accesses a specific web server or the media server 120 and is automatically prepared and updated by the web browser installed in the client 100.

The advertisement server 130 receives the cookie information prepared by the client 100 from the client 100 or from the media server 120 or the web server and enables to provide the Internet advertisement by the use of the received cookie information.

The advertisement server 130 receives the advertisement exposure information such as the advertisement exposure position and size of an area, that is, the web page, to which the advertisement is provided from the media server 120 or the web server (S302).

The advertisement server detects the advertisement data by the use of the received cookie information and advertisement exposure information to read the advertisement data (S304) and transmits the read advertisement data to the client 100 (S306).

It is assumed now that user A first accesses site B and then moves to site C and site D.

Different kinds of advertisements were provided by sites and different exposure positions or sizes and different advertisement providing methods were different by sites.

However, in the invention, by grasping that the user is identical by the use of the cookie information generated when a user accesses a site and receiving the information on the advertisement exposure position and size and the advertisement providing method from the site accessed by the user, it is possible to expose the identical advertisement to the user by the use of the received information.

Accordingly, when a user moves to a different site or changes a web page in the identical site, it is possible to provide a user with an identical advertisement.

The above-mentioned embodiments of the invention are intended to exemplify the invention and various corrections, modifications, and additions can be made thereto by those skilled in the art without departing from the spirit and scope of the invention. The corrections, modifications, and additions are included in the appended claims.

### INDUSTRIAL APPLICABILITY

As described up to now, according to the digital processors including the service module according to the invention and the additional service providing method using the digital processor, a user of the digital processor can be provided with an additional service without subscribing in a specific communication provider.

As described above, according to the identical Internet advertisement providing method and system, it is possible to provide an identical advertisement to a user, regardless of the change in web site or web page.

When a web site or web page is changed, the advertisements provided in the web sites or web pages are identical to each other, thereby maximizing the advertisement effect.

1. An identical Internet advertisement providing method comprising the steps of:
(a) receiving cookie information from a client;
(b) receiving advertisement exposure information from a server to which the client is being connected;
(c) reading advertisement data using the received cookie information and advertisement exposure information; and
(d) transmitting the read advertisement data to the client.

2. The method according to claim 1, wherein the cookie information in the step of
(a) is received from a web browser installed in the client.

3. The method according to claim 1, wherein the cookie information in the step of
(a) is received through the server to which the client is being connected.

4. The method according to claim 1, wherein the cookie information in the step of
(a) includes user information of the client, and
wherein the advertisement data in the step of (c) is read using the user information.

5. The method according to claim 1, wherein the advertisement exposure information in the step of (b) includes at least one of a size, a position, and a display method of a window on which the transmitted advertisement data is displayed.

6. The method according to claim 1, wherein the step of (c) reading the advertisement data is carried out by generating a query using the cookie information and the advertisement exposure information.

7. The method according to claim 1, wherein the step of (d) transmitting the read advertisement data to the client is carried out even when the server to which the client is being connected is changed.

8. An identical Internet advertisement providing system comprising:
a cookie information receiver receiving cookie information from a client;
an advertisement exposure information receiver receiving advertisement exposure information from a server to which the client is being connected;
an advertisement data detector reading advertisement data using the cookie information and the advertisement exposure information received by the cookie information receiver and the advertisement exposure information receiver, respectively; and
an advertisement data transmitter transmitting the advertisement data read by the advertisement data detector to the client.

9. The system according to claim 8, wherein the cookie information receiver receives the cookie information from a web browser installed in the client.

10. The system according to claim 8, wherein the cookie information receiver receives the cookie information through the server to which the client is being connected.

11. The system according to claim 8, wherein the cookie information received by the cookie information receiver includes user information of the client, and wherein the advertisement data detector reads the advertisement data using the user information included in the cookie information.

12. The system according to claim 8, wherein the advertisement exposure information received by the advertisement exposure information receiver includes at least one of a size, a position, and a display method of a window on which the transmitted advertisement data is displayed.

13. The system according to claim 8, wherein the advertisement data detector reads the advertisement data by generating a query using the cookie information and the advertisement exposure information.

14. The system according to claim 8, wherein the advertisement data transmitter transmits the read advertisement data to the client even when the server to which the client is being connected is changed.

15. A recording medium having recorded a program of instruction words that can be read and executed by a digital processor so as to embody an identical Internet advertisement providing method, the identical Internet advertisement providing method comprising the steps of:
(a) receiving cookie information from a client;
(b) receiving advertisement exposure information from a server to which the client is being connected;
(c) reading advertisement data using the received cookie information and advertisement exposure information; and
(d) transmitting the read advertisement data to the client.
